(19) United States
(12) Patent Application Publication
(10) Pub. No.: US 2026/0316345 A1
(43) Pub. Date: Oct. 15, 2026

(54) TIMEPIECE COMPONENT AND METHOD FOR MANUFACTURING A TIMEPIECE COMPONENT

(71) Applicant: ROLEX SA, Geneva (CH)

(72) Inventor: Benjamin Celant, Geneva (CH)

(73) Assignee: ROLEX SA, Geneva (CH)

(21) Appl. No.: 19/105,507

(22) PCT Filed: Aug. 28, 2023
(86) PCT No.: PCT/EP2023/073500

§ 371 Date: Feb. 21, 2025

(30) Foreign Application Priority Data
Aug. 31, 2022 (EP) 22193319.5

(51) Int. Cl. B29C 33/56; B29C 37/00; B29K 21/00; B29L 31/00

(52) U.S. Cl. CPC B29C 33/56; B29C 37/0053; B29C 2793/00; B29K 2021/00; B29K 2995/0018; B29L 2031/739

(57) ABSTRACT

The timepiece component (10; 10*), in particular a bracelet portion, has a substrate (1; 1*) made of polymer material comprising reliefs (111; 111*) and at least in part a deposit of material (4; 41*, 42*), and all or part of the reliefs (111; 111*) is covered by a transparent or translucent protective layer (2; 2*).

The present invention relates to a method for manufacturing a timepiece or jewelry component. It also relates to a timepiece component as such, in particular a bracelet (wrist strap) portion, more particularly a bracelet portion made of polymer, such as an elastomer, obtained by such a method.

In the field of timepieces, it is common practice to form a bracelet portion from a polymer material, in particular elastomer. It is desirable to be able to form a surface of such a bracelet portion having a selected, particularly attractive, appearance.

To achieve such a result, it is known practice to manufacture a bracelet portion using a metal mold made of steel, the geometry of which directly forms a predefined texture on the bracelet portion. The first disadvantage of such an approach is the lack of versatility, since changing the appearance of the bracelet requires changing the mold. Such a solution is therefore not suitable for small-scale production. It also has the second disadvantage of not allowing just any texture to be obtained, or producing textures with insufficient accuracy and/or non-optimal visibility. Lastly, creating a textured surface on the mold is often complex and difficult to achieve, and such a surface cannot be repaired in the event of damage, which represents a third disadvantage of this solution.

Another complementary approach is to modify the appearance of the surface of the bracelet portion after it is taken out of a mold, by one or more additional finishing steps, for example by a calendering step. Such an approach likewise complicates the method by adding one or more additional steps. Moreover, it does not allow the formation of all types of textures.

Thus, it is the aim of the present invention to improve the known methods for manufacturing a timepiece or jewelry component, and in particular to achieve all or some of the following aims.

The first aim of the invention is to be able to manufacture a timepiece or jewelry component having a defined technical functionality, and/or an attractive esthetic appearance, in particular having a structured surface that is at least partially protected.

The second aim of the invention is to be able to manufacture a timepiece or jewelry component comprising a structured surface of complex shape.

The third aim of the invention is to be able to manufacture a timepiece or jewelry component comprising a structured surface suitable for small-scale production, in particular with the goal of being able to easily change the pattern of the structured surface of the timepiece component to be manufactured.

To this end, the invention is based on a method for manufacturing a timepiece component, wherein it comprises the following steps:
Forming reliefs on a polymer substrate of the timepiece component;
Depositing material on at least a part of said substrate;
Integrally joining a transparent or translucent protective layer to all or some of said reliefs and/or of the deposit of material.

The invention also relates to a timepiece component made of polymer material, or predominantly polymer material, in particular a bracelet portion, wherein it comprises a substrate made of polymer material comprising reliefs and at least partially a deposit of material, and wherein all or some of said reliefs are covered by a transparent or translucent protective layer.

The invention is more particularly defined by the claims.

These aims, features and advantages of the present invention will be explained in detail in the following description of particular non-limiting embodiments, provided with reference to the attached figures in which:

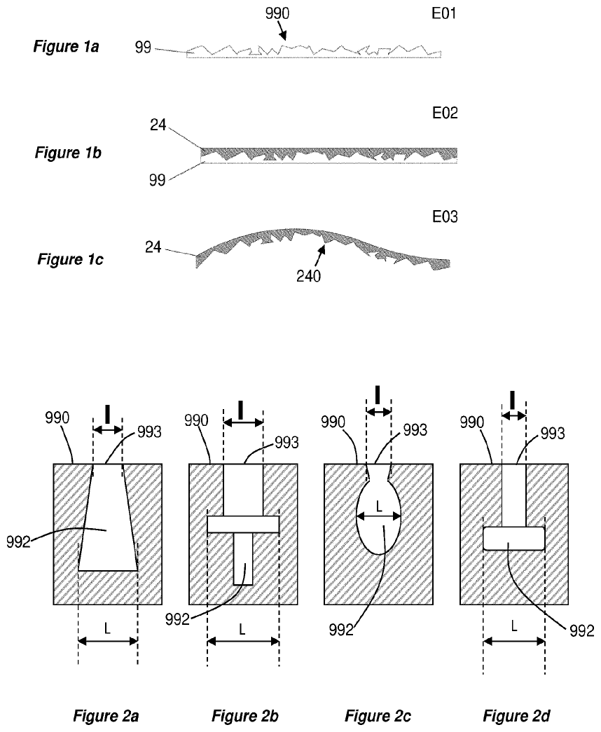

FIGS. 1a to 1c depict the steps of a first phase of manufacturing of a structured insert according to a first variant of a first embodiment of the invention.

FIGS. 2a to 2d show views in cross section of cavities formed in the surface of a model element according to examples of implementation of the first phase of the invention.

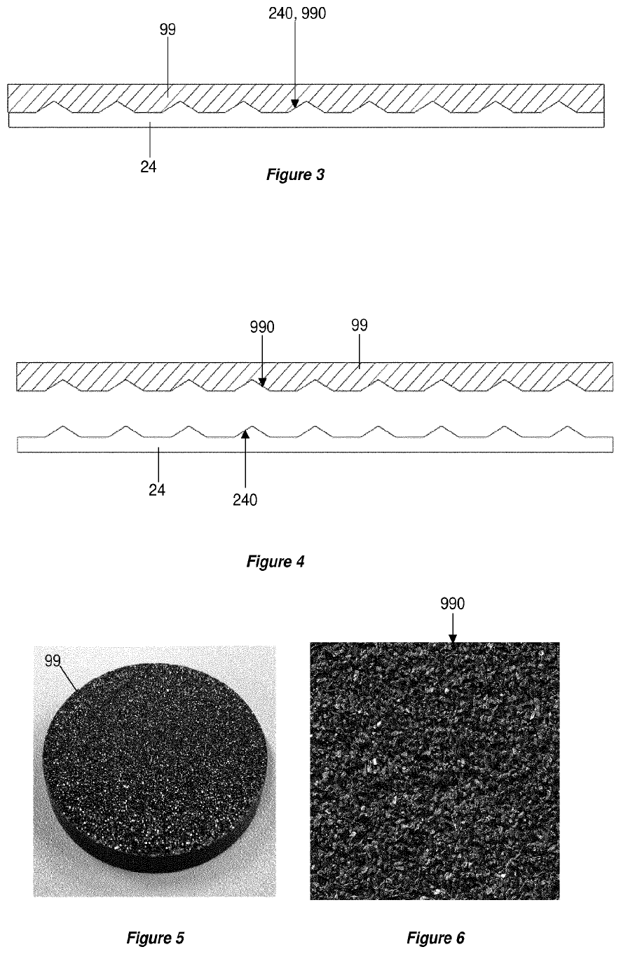

FIG. 3 schematically depicts the step according to FIG. 1b of the first phase of manufacturing of a structured insert according to the first variant of the first embodiment of the invention.

FIG. 4 schematically depicts the step according to FIG. 1c of the first phase of manufacturing of a structured insert according to the first variant of the first embodiment of the invention.

FIG. 5 depicts a model element used by the method according to the first variant of the first embodiment of the invention.

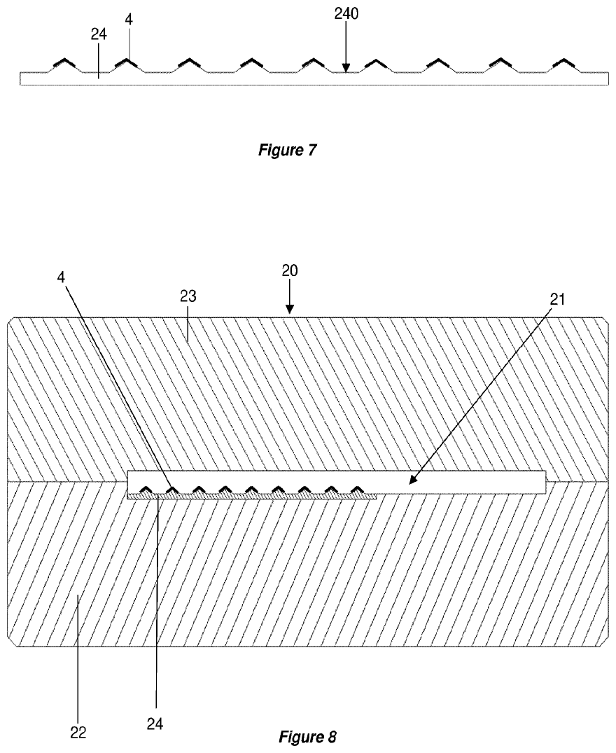

FIG. 6 shows an enlarged view of the structured surface of the model element of FIG. 5.

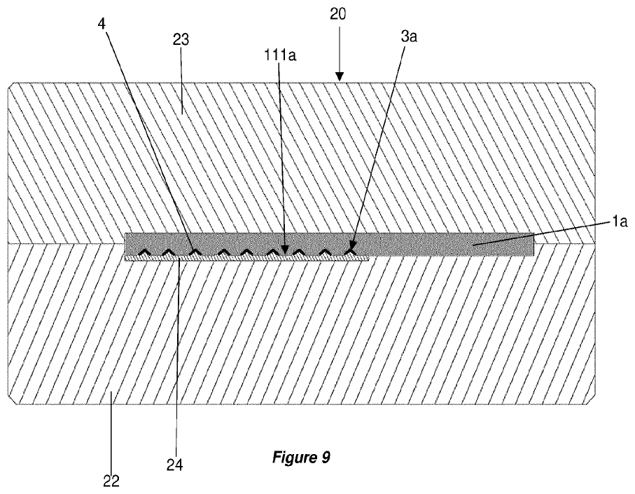

FIGS. 7 to 9 schematically depict the steps of a method for manufacturing a timepiece component according to a first embodiment of the invention.

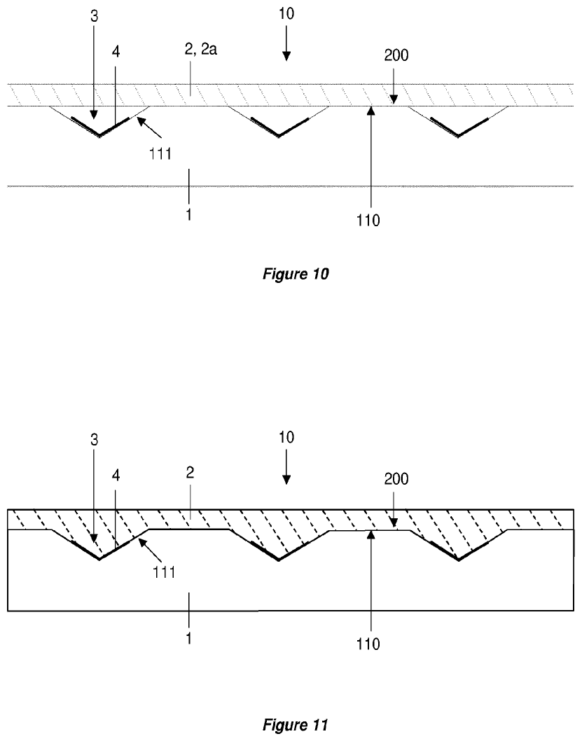

FIGS. 10, 11 and 12 depict views in cross section of a timepiece component according to different variants of a first embodiment of the invention.

FIG. 13 shows a top view of the timepiece component of FIG. 10 according to a first embodiment of the invention.

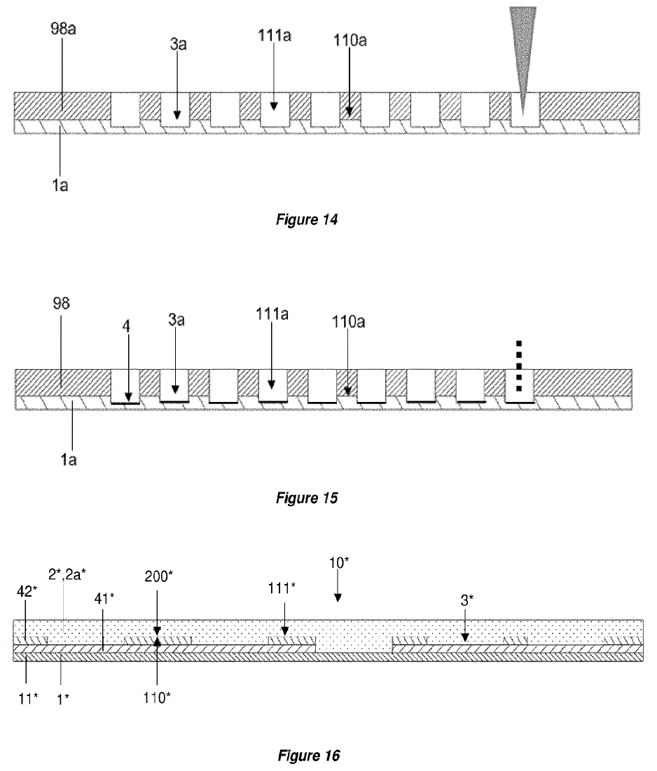

FIGS. 14 and 15 schematically depict the steps of a method for manufacturing a timepiece component according to an example of a second variant of the first embodiment of the invention.

FIG. 16 schematically depicts a view in cross section of a timepiece component according to a second embodiment of the invention.

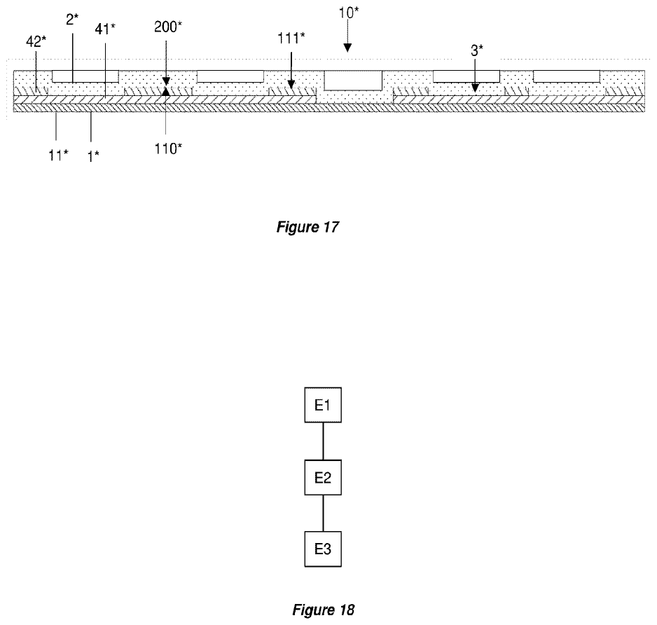

FIG. 17 schematically depicts a view in cross section of a timepiece component according to a variant of the second embodiment of the invention.

FIG. 18 schematically depicts the steps of the method for manufacturing a timepiece component according to the invention.

Embodiments of the invention will now be described in the context of the manufacture of a bracelet portion. The invention may of course be used for the manufacture of another timepiece or jewelry component, for example a bezel disk or a dial.

According to a first variant of a first embodiment of the invention, the manufacturing method firstly comprises a first phase of manufacturing a structured insert, intended to be inserted in a mold for manufacturing a timepiece or jewelry component for forming a structured surface of the timepiece component of which at least part of a substrate is manufactured in such a mold.

According to this first variant, the method for manufacturing a timepiece component therefore comprises a first phase of manufacturing a structured insert for a mold for manufacturing a timepiece component, depicted schematically in FIG. 1.

The first phase comprises a first step consisting in acquiring E01 a model element 99 comprising a structured surface 990 with a pattern to be reproduced. The pattern of the structured surface of this model element is called a “master pattern”: this is an existing pattern that is to be reproduced identically, with very high accuracy, on a surface of a bracelet portion, for example. The model element, which may also be referred to as a “master”, is depicted by way of examples in FIGS. 5 and 6.

A structured surface means a surface which has reliefs, positive and/or negative, that is to say projecting or recessed relative to said surface. These reliefs form a master pattern of the structured surface. Furthermore, this structured surface may be flat or not flat, for example curved. As will become clear from the description below, the method according to the invention advantageously makes it possible to reproduce a wide variety of master patterns, including complex patterns and/or patterns involving very small dimensions, in particular micrometric or even nanometric. Naturally, the invention does not relate to the master pattern as such, which may be any master pattern.

For example, the master pattern may be a natural pattern, such as that found on the surface of animal skin, leather, alligator skin, bark, a leaf, microcrystals, notably silicon carbide crystals or ruthenium crystals, etc. Alternatively, it may be unnatural, artificial, and made on a substrate, natural or not natural, by any known technique such as traditional machining, laser etching, etc. It may for example be formed by a metal textured by abrasion, in particular forming a sunbrushed or any other form of satin finish, by traditional etching, by laser or by electrochemistry, or by a wafer presenting electroformed decorations obtained by deposition of a metal in the cavities of a photopolymerized photosensitive resin, or by a surface of a silicon wafer, or by weaving of fibers, etc. More generally, the master pattern, in the case where it is unnatural or artificial, may be obtained by any known technique. The master pattern may be produced on a substrate, the master pattern and the substrate forming the model element. Alternatively, the master pattern may be obtained when manufacturing the model element. For example, the model element and/or the master pattern may be obtained by additive manufacturing or 3D printing. Such a method for manufacturing the model element and/or the master pattern has the advantage of creating varied and complex decorations, quickly and with great versatility.

As mentioned above, the master pattern may be complex. For example, it may comprise hollow portions forming cavities of complex shape, in particular having an opening narrower than its width or more broadly comprising a lower section parallel to the structured surface of larger area than another parallel section superimposed above the lower section, i.e. having a shape such that it exhibits a bottleneck when demolding the cavity.

FIGS. 2a to 2d illustrate examples of complex cavities seen in cross section, in a plane perpendicular to the structured surface 990 of a model element, which structured surface 990 thus comprises at least one such complex cavity 992, or a multitude of complex cavities, identical or different. Such a complex cavity 992 comprises an opening 993 opening onto the structured surface 990, then extends into the depth of the model element. This complex cavity 992 comprises at least one section, as shown in these figures, such that the greatest width L of this section in a plane parallel to the structured surface 990 is greater than the width I of the opening 993. More generally, a complex cavity may comprise a first section parallel to the structured surface 990 of the model element with a larger area than a second superimposed parallel section positioned above this first parallel section, i.e. closer to the opening 993. The specificity of these cavity shapes lies in the fact that they induce complexity in a demolding step of an injection molding method, which includes the injection molding of a material in such a cavity, since the cavity comprises a narrow section forming a bottleneck upon removal of the solidified injected material.

Complexity may also stem from a very large number of reliefs, projecting and/or recessed, which may be juxtaposed or intersecting.

Lastly, complexity may come from the resolution of the master pattern, which may involve very small dimensions. By way of example, the structured surface 990 of the model element may comprise at least one relief having a height, measured in the direction perpendicular to the structured surface 990, of between 1 nm and 2 mm, or between 1 nm and 500 μm, or between 1 nm and 10 μm, or between 1 nm and 10 nm. Thus, the structured surface 990 of the model element may comprise at least one millimeter relief or at least one micrometer relief or at least one nanometer relief, or a combination of millimeter reliefs and/or micrometer reliefs and/or nanometer reliefs.

Since the invention allows the reproduction of complex patterns, it has the advantage of being compatible with the reproduction of very varied textures. It is naturally compatible with any other texture in addition to the examples illustrated, and may also be implemented to reproduce simple textures.

The first phase of the method then comprises a second step consisting in covering E02 said structured surface of the model element 99 with a molding resin, as shown in FIGS. 1b and 3, capable of reproducing, in negative, a pattern of said master pattern of the model element, after solidification of the molding resin, to obtain a structured insert 24.

Advantageously, the molding resin has a viscosity before solidification at ambient temperature and pressure of between 0.5 and 70000 Pa·s⁻¹, or between 0.5 and 30000 Pa·s⁻¹, or between 0.5 and 1000 Pa·s⁻¹. This favors its infiltration into cavities, including complex cavities, of the structured surface of the model element 99. It thus penetrates into the smallest corners of the structured surface of the model element 99, to reproduce with very high accuracy the shape of this structured surface. As it solidifies, all the details of the surface to which the molding resin has been applied are reproduced very accurately. The accuracy of reproduction may be on a micrometric scale, or on a nanometric scale.

For example, the molding resin comprises polyurethane, latex, acrylic resin, fluoroelastomer such as FKM, PDMS (PolyDimethylSiloxane), epoxy resin, or two-component silicone, in particular with two addition-vulcanizing components, in particular from the vinyl-polydimethylsiloxane family, or in particular comprising vinyl, silicic acid and aggregating materials. The molding resin may further comprise one or more additives selected from an adjuvant, an aggregating material, and a colorant.

Alternatively, a more viscous resin, or a paste or solid material, such as raw fluorocarbon rubber (FKM), may also be used. In such a case, significant pressure will advantageously be applied to this resin to allow it to infiltrate all the reliefs, in particular the cavities, of the model element. A compromise will be sought to define the pressure applied to achieve accurate reproduction of the master pattern without damaging the model element.

After solidification, the molding resin forms a structured insert 24. Preferably, this structured insert 24 is flexible. In particular, its flexibility is suitable for demolding it from the model element 99, in particular in the case where this model element includes a pattern with complex cavities. Advantageously, the molding resin has little or no shrinkage, in order to faithfully reproduce and preserve the characteristics of the pattern to be reproduced. For example, the shrinkage is less than or equal to 2%, or even less than or equal to 1%. The molding resin is chosen so as to achieve, once solidified, a flexibility compatible with the extraction stress, calculated using the following formula:

$$1 - [ \frac{Minimum dimension of the extraction opening}{Maximum internal dimension} ] = Extraction stress ( in \% )$$

The higher the extraction stress, the more flexible and elastic the molding resin must be so that the resulting structured insert can be removed without damage, while preserving the entire texture to be replicated. In other words, the molding resin is chosen so as to form a structured insert 24 which can be separated from the model element without damaging either the model element or the structured insert.

Preferably, the solidification of the molding resin, at the end of which the impression of the master pattern is considered to be made, corresponds to its polymerization. It consists of two stages: setting the resin, after which the resin is dry to the touch, then curing the resin, after which the final mechanical properties of the resin are obtained.

The kinetics of polymerization of the molding resin for taking impressions are generally rapid. In particular, the polymerization time at ambient temperature may be between 1 and 30 minutes, preferably between 1 and 15 minutes. For example, in the specific case of the use of two-component silicone, the setting time at ambient temperature (20° C.) is between 15 and 90 seconds. The curing time is between 1 and 10 minutes. The choice of this silicone as molding resin is therefore particularly advantageous: its solidification time is short and this silicone may be used with a very simple facility.

The method then comprises a third step consisting of separating E03 the structured insert 24 from the model element 99, as depicted in FIGS. 1c and 4, this structured insert 24 comprising a structured surface 240 reproducing the master pattern in negative.

As mentioned above, the solidified molding resin retains a flexibility which allows it to be easily demolded from the model element 99, without damaging the pattern of the structured surface 240. The structured insert 24 thus comprises a structured surface 240, which corresponds to the identical reproduction, in negative, of the structured surface 990 of the model element 99.

The model element is preferably cleaned beforehand, prior to applying the molding resin in order to provide a receiving surface, including the structured surface to be reproduced, which is perfectly clean at the time of application of the molding resin.

Optionally, this surface may also be coated with a release agent. This facilitates the separation of the structured insert 24 from the model element 99, the structured insert coming away easily, without adhering to the model element. The molding resin therefore leaves no residue on the surfaces of the model element, and retains an intact structured surface, not damaged by any pieces being torn off, perfectly reproducing the structured surface of the model element.

Advantageously, the structured insert is resistant to compression while still being quite flexible, which is reflected in a hardness of between 20 and 90 Shore A, or between 20 and 40 Shore A or between 50 and 70 Shore A or between 80 and 90 Shore A. As stated above, this resistance, combined with the flexibility of the insert, is adapted to the model element used.

Furthermore, the structured insert 24 obtained is sufficiently flexible to be able to follow the shape, which may be non-flat, of the surface of the mold on which it is intended to be positioned, as will be described in detail below. For this purpose, the apparent modulus of the structured insert 240 for a deformation of 100% is advantageously less than 300 MPa, or less than 50 MPa, or less than 10 MPa. On the other hand, the tear strength without a nick of the structured insert 24, according to standard ISO 34-1 B (a), is preferably greater than or 5, or greater than 10.

According to an advantageous embodiment, after this step of demolding the molding resin, the structured insert 24 is directly obtained. Optionally, the method includes an additional step of cutting the molding resin separated from the model element to form the structured insert in its final format. Naturally, according to an advantageous embodiment, the structured insert 24 may be manufactured in the first phase according to a shape at rest (corresponding to the shape of the model element) which corresponds to the shape of the housing of the mold, such that it will be perfectly adapted to this housing without (or with little) need to deform it.

Moreover, the method may comprise an optional additional step of depositing a coating of a release agent on the structured insert 24, in particular by coating, by chemical vapor deposition (CVD), by physical vapor deposition (PVD), by atomic layer deposition (ALD), by sol-gel deposition, by SAM (Self Assembled Monolayer) deposition, or by depositing a fluorinated coating on the structured insert, for example made of a material selected from polytetrafluoroethylene (PTFE), fluorinated ethylene propylene (FEP), or perfluoroalkoxy (PFA).

According to a first alternative of the first phase described above, the structured insert 24 may be manufactured differently, in a simplified manner, for example independently of any model element. The advantage of the approach using a model element is that it allows for very accurate and realistic production, but the invention is naturally not limited to such an approach. Thus, the structured insert 24 may include any pattern, for example be manufactured by electroforming, by electroerosion, or by additive manufacturing or 3D printing.

According to a second alternative, the structured pattern may be manufactured directly on a half-cavity block of the manufacturing mold which will be described below, in which case the method no longer comprises the first phase of manufacturing an insert, but a first phase of manufacturing a structured surface 240 directly on a surface of the manufacturing mold.

The method for manufacturing a timepiece component then comprises a second phase of manufacturing a timepiece component as such, depicted in FIGS. 7 to 9, which uses the structured insert 24 manufactured by the first phase described above, or at least one structured surface 240, which has the function of forming reliefs on a surface of a timepiece component, as will be described in detail below.

According to this first variant of the first embodiment of the invention, the second phase of manufacturing the timepiece component as such comprises the following steps.

One step consists in depositing a material 4 on the structured surface 240 of the structured insert 24 or of a half-cavity block 22 of a manufacturing mold 20, by deposition of material 4 on the positive or projecting reliefs of the structured surface 240, as shown in FIGS. 7 and 8.

According to this embodiment, the material 4 comprises pigments featuring a particular color, in particular a color which is different, even substantially different, from that which will form a substrate 1 of the timepiece component, as will be described in detail below. The material 4 may also generate any visual or functional effect, in addition to or instead of a coloring, such as for example a metallic, pearly, or glittery effect. The material 4 may also be phosphorescent or fluorescent. Furthermore, the material 4 is not necessarily visible to the naked eye.

This material 4 may for example be in the form of a paint, a lacquer, a varnish, or a composite, in particular a luminescent composite, capable of withstanding the temperatures used in the subsequent injection molding and/or compression molding steps. The material 4 may for example be applied by roller on the projections of the structured surface 240 or by any other technique known to those skilled in the art such as printing, screen printing, or decalcomania.

In the embodiments using a structured insert 24, the method implements a step consisting in placing the structured insert 24, the structured surface 240 of which comprises the deposit of material 4, in a cavity 21 of a mold 20 used for the manufacture of the blank 1a of a substrate 1 of the timepiece component, in particular on a first half-cavity block 22 delimiting said cavity 21 in collaboration with a second half-cavity block 23, as shown in FIG. 8. In this step of placing the structured insert 24 in a mold 20 of a timepiece component, said mold 20 is advantageously made of metal, for example steel. Advantageously, this is achieved by simple insertion into a housing provided for this purpose in the mold 20, with a sufficiently tight fit to cause the structured insert 24 to be held in place. The latter is therefore advantageously held in place in the mold without adhesive or attachment. This housing in the mold has a shape and a thickness corresponding to those of the structured insert.

The structured insert 24 may have any shape, and occupy all or part of the surface of the mold 20, in particular of a half-cavity block. In addition, it has sufficient flexibility to perfectly follow the shape of the housing intended to receive it, without leaving any gaps. Thanks to its material it moreover does not adhere to the mold. It may therefore be removed easily, without the need to add a release agent to the surface of the mold.

The method then comprises a step of filling the cavity 21 of the mold with a material of the component, to form a blank 1a of the substrate 1 of the timepiece component, as shown in FIG. 9. This may be an injection molding or compression molding step. In the case of the former, the material is in the form of a pasty or fluid raw material which is injected into the cavity 21 of the mold 20 at a predetermined pressure (typically between 80 bar and 150 bar, or between 80 bar and 90 bar), with the mold already closed and at a given temperature (typically between 100° C. and 200° C.). In the case of the latter, a raw blank or preform is positioned on a mold part before closing the mold, then compressed at a given temperature (typically between 100° C. and 200° C.). This filling of the mold includes filling the negative pattern of the structured surface 240. The material of the component is then partially cooled and solidified.

At the end of this step, the blank 1a includes a pattern 111a which is the identical reproduction of the pattern of the structured surface 240. In addition, the deposit of material 4 on the positive or projecting reliefs of the structured surface 240 has been transferred into the cavities 3a of the pattern 111a of the blank 1a of the substrate 1 featuring the cavities 3 of the pattern 111 of the substrate 1. This phenomenon can be explained in particular by the fact that the material 4 adheres to the blank 1a upon crosslinking of the material of the component constituting same, a phenomenon which may be further facilitated if the material 4 does not adhere very strongly to the insert 24.

The parameters of this step (duration, pressures, temperatures, etc.) are chosen in particular so as to obtain a blank 1a in which the material is not completely crosslinked and the format of which does not yet correspond entirely to that of the substrate 1 in order to allow the implementation of the integral joining step described below. Thus, the pattern 111a may not correspond identically to the pattern 111 which will be visible on the finished timepiece component 10 as shown in FIGS. 10, 11 and 12.

Advantageously, the material of the component is a polymer, in particular an elastomer or based on elastomer, i.e. comprising at least 50% by weight of elastomer. In particular, the elastomer material may be a fluoroelastomer (FKM, FFKM or FEPM), or a natural rubber (NR) or synthetic rubber (SBR, HNBR, EPDM), or a vinyl methylsilicone (VMQ) or a fluorosilicone (FVMQ). Alternatively, the material of the component is a polymer, thermoplastic or thermoset. Such a material notably has the advantage of facilitating the separation of the insert from the component without damaging the latter. The choice of the material of the component is such that it is suitable for a more or less complex specific shape of the timepiece component to be manufactured, the most complex shapes requiring the use of a component material having more efficient mechanical properties than the insert 24. In this case, in particular, it is of course envisageable for the insert 24 to be destroyed when removing the blank 1a from the mold.

The timepiece component is thus advantageously flexible. In addition, it may have a non-flat shape at rest, induced by the shape of the manufacturing mold. This shape may be curved or arched, notably concave or convex. Thus, the timepiece component may be curved or arched, notably concave or convex. The timepiece component may be rigid at rest, that is to say, retain a predefined shape at rest, which may advantageously be modified by elastic deformation or by shaping, at ambient temperature or otherwise, in particular in the case of a bracelet, by virtue of the flexible material used.

Note that the molding resin of the structured insert 24 is naturally chosen so as to be compatible with the conditions of filling of the mold 20 with the material of the blank 1a. In particular, the structured insert 24 can withstand the conditions of vulcanization of the elastomer forming the blank 1a or the timepiece component 10. To this end, it can withstand temperatures of 160° C., or even up to 180° C., even up to 250° C., for at least 15 minutes and preferably for several hours. At these temperatures, the structured insert 24 can also withstand pressures between 80 bar and 150 bar, or even between 80 bar and 90 bar, without deformation. In addition, the structured insert 24 can advantageously withstand, for example, several elastomer vulcanization cycles, lasting 5 to 15 minutes each. Similarly, the material 4 can withstand the conditions of vulcanization of the elastomer forming the timepiece component 10.

The step of filling the mold 20 therefore advantageously comprises the casting, injection molding or compression molding of the material of the component, and makes it possible to form a timepiece component comprising a structured surface in one piece.

The method then comprises a step of removing the blank 1a of the timepiece component 10 from the mold 20.

Advantageously, in this removal step, the structured insert 24, where applicable, remains integrally joined to said blank 1a, since they are interconnected in the region of the structured surface, and because the structured insert is not attached to the manufacturing mold. In this case, the structured insert 24 fulfills a second function of temporary protection of the structured surface of the blank of the timepiece component, in particular to allow a sub-step of deburring or sandblasting on leaving the mold. The method then comprises a step of separating the timepiece component blank from the structured insert 24, where applicable.

Alternatively, the structured insert 24 may be separated from the blank 1a during the step of demolding said blank from the mold 20. This structured insert 24 may possibly be reused within the mold to manufacture a new blank and another identical timepiece component.

The filling step described above thus simultaneously implements the following two steps of the manufacturing method according to the invention:
Forming E1 reliefs on a substrate of the timepiece component;
Depositing E2 material on at least a part of said reliefs.

The method then implements a step consisting in integrally joining E3 a transparent or translucent protective layer 2 to the blank 1a of the substrate 1 obtained by the previous steps. For this purpose, a blank 2a of the transparent or translucent protective layer 2 is used. This blank 2a includes a material that is not completely crosslinked and/or has dimensions which are not definitive. According to the embodiment, this integral joining step E3 compresses the blanks 1a and 2a against one another at predetermined pressures and temperatures and for predetermined durations so as to integrally join the two blanks 1a, 2a to one another.

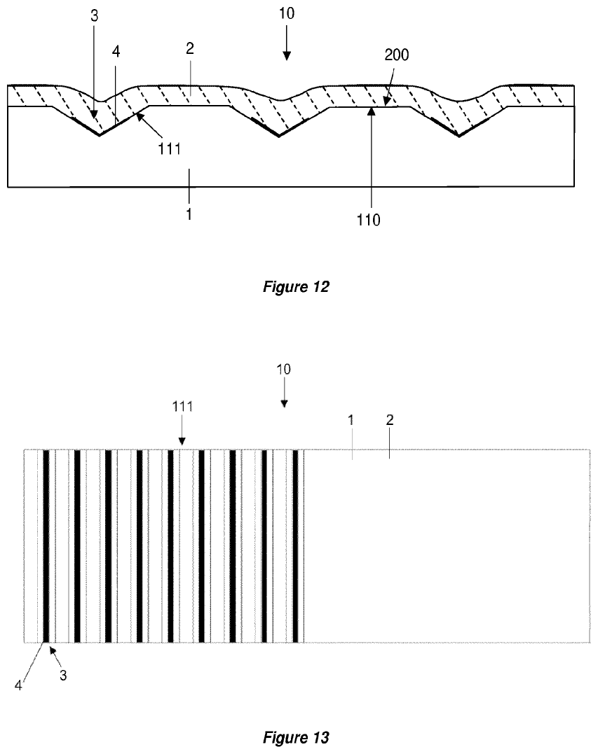

Depending on the flexibility of the blank 2a and the pressure and temperature conditions, the two blanks 1a and 2a may be integrally joined partially or fully. The parts 1 and 2 of the component 10 may thus be integrally joined only on the upper surface 110 of the substrate 1 and the lower surface 200 of the layer 2, as shown in FIG. 10. They may also advantageously be integrally joined over all of the surfaces of the reliefs 111 and the lower surface 200 of the layer 2, as shown in FIGS. 11 and 12, in particular in a manner conforming to the reliefs 111 (FIG. 12).

Thus, step E3 makes it possible to obtain a timepiece component 10 comprising a second transparent or translucent protective layer 2 the lower surface 200 of which is in contact with at least the upper surface 110 of the substrate 1.

Note that this method may advantageously be implemented using blanks 1a, 2a of the substrate 1 and of the transparent or translucent protective layer 2 having large dimensions, which are then cut to the correct format after being integrally joined, for example to form one or more bracelet portions provided with a substrate 1 integrally joined to a second transparent or translucent protective layer 2 using a single blank 1a.

Advantageously, the respective materials of the first and second blanks 1a, 2a, that is to say of the substrate 1 and of the transparent or translucent protective layer 2 of the timepiece component are compatible with one another, such that the two layers 1, 2 adhere to one another independently of any additional means such as an adhesive. In particular, these materials may be polymers, which are selected so as to have the same chemical nature in order to promote crosslinking between them. Preferably, the polymers selected belong to the same chemical family, in particular the family of fluoroelastomers. In other words, the materials of the first and second blanks 1a, 2a, or of the substrate 1 and of the transparent or translucent protective layer 2, comprise the same polymer matrix.

As specified above, the use of a structured insert is not mandatory in this first variant of the first embodiment of the invention, but nevertheless represents an advantageous embodiment.

The structured insert may be single-use or may be used for the manufacture of a small number of timepiece components, for example up to 50 timepiece components.

According to a second variant of the first embodiment, the deposition of material 4 and possibly the production of reliefs are carried out after the step of injection molding or compression molding in a mold of the blank of the timepiece component substrate.

In a first example of implementation of this second variant, the method differs from the method according to the first variant in that the step of deposition of material 4 is carried out after structuring of a component blank in a mold. In this case, the blank with reliefs may be formed following exactly the same steps as described previously, without carrying out the step of deposition of material on the structured surface 240 of a structured insert 24 or directly on a surface of the mold 20.

In this first example, a blank of a timepiece component is therefore formed in a mold comprising a structured surface which is reproduced on a surface of the blank. This step makes it possible to carry out a first step of forming E1 reliefs on a substrate of the timepiece component. Then, in this first example, the step of deposition E2 of material on at least some of the reliefs is carried out after removing the blank from the manufacturing mold.

This step of deposition E2 of material may be carried out using the same materials and the same methods as described previously, but with direct application to the reliefs of the blank, rather than to the structured surface of an insert or a half-cavity block of the mold with a view to subsequently being transferred to the insert when it is being shaped. This material may be selectively deposited on projections or recessed areas of said reliefs of said blank.

According to a second example of implementation of this second variant embodiment, the method comprises a simplified phase of preparation of a blank of a substrate of a timepiece component. This blank does not include any relief or deposit of material. It may be formed by calendering (in the case of a blank made of raw material) or molding, the mold used in the possible molding step then being simplified compared to the other variants and alternatives described, owing to the fact that it does not include a structured surface. The use of a structured insert is therefore not necessary. In addition, the surface of the mold is simplified since it does not have a structured surface. Alternatively, the blank of a substrate may be produced by any other method.

The method then comprises a first step of forming E1 reliefs on at least part of the blank 1a of the timepiece component substrate. This first step of forming E1 reliefs may be a step of structuring the upper surface 110a of the blank 1a consisting in forming cavities 3a using a laser, in particular a femtosecond pulse laser, the trajectory of which is defined so as to correspond to a pattern 111a prefiguring the pattern 111 of the substrate 1.

In a particular variant, the first step of forming E1 reliefs may consist in affixing a plate 98a featuring a mask or a stencil provided with cavities on or at a distance from an upper surface 110a of the substrate blank 1a, as shown in FIG. 14. Next, the blank 1a is etched, this etching creating cavities 3a forming reliefs according to a pattern 111a through the plate 98a. Thus, cavities are also formed on the plate 98a in line with the cavities 3a. In this particular variant, the mask or stencil 98 thus formed may be kept for the implementation of the material deposition step E2, thus making it possible to locate the deposit of material 4 within said cavities 3a, as shown in FIG. 15.

In this second example, the step of deposition E2 of material on at least part of said surface having reliefs is carried out as in the first example.

Thus, in all the examples of this second variant embodiment, the step of deposition E2 of material 4 consists in depositing at least one layer of material 4 by any technique known to those skilled in the art. This may involve a step of applying a paint, a lacquer, a varnish or a composite, in particular a luminescent composite, by any technique known to those skilled in the art, such as a spraying technique or by means of a brush. Alternatively, it may involve depositing a layer of metal or metal alloy in the cavity 3a by any technique known to those skilled in the art, such as for example physical vapor deposition (PVD), chemical vapor deposition (CVD) or atomic layer deposition (ALD). Depending on the technique chosen for implementing this step of deposition of material E2, a mask or a stencil previously manufactured during the step may optionally be used.

According to an alternative embodiment, the step of deposition E2 of material 4 may also consist of several depositions of different layers of material. For example, a first metal adhesion layer may first be deposited within the cavities 3a in order to allow improved adhesion of a layer of paint, varnish or lacquer within said cavities 3a.

Lastly, according to this second variant embodiment, the step consisting in integrally joining E3 a blank 2a of a transparent or translucent protective layer 2 to the blank 1a of the substrate, obtained in previous steps, is then carried out. This is identical to what has been described above for the first variant embodiment.

According to a second embodiment, shown in FIG. 16, the method for manufacturing a timepiece component comprises the following steps:
Acquiring a first layer 11* of polymer, without reliefs, of a substrate 1* or of a blank of a substrate 1*;
Depositing E2 at least one layer of material 41*, 42* on the first layer 11* and partially removing said material 41*, 42*, in such a way as to form E1 reliefs on said substrate 1* by means of said deposition of material;
Integrally joining E3 a transparent or translucent protective layer 2* to said substrate 1*.

Thus, according to this second embodiment, the reliefs of the substrate are not formed separately from a contribution of material, but the reliefs are formed by means of a deposition of material. In other words, the deposition of material here fulfills the dual function of, on the one hand, modifying the visual appearance, for example the color(s), of the surface of the component (relative to a component having the same reliefs but obtained without the added material), as in the first embodiment, and on the other hand, forming reliefs. Moreover, unlike the first embodiment, the step of deposition E2 of material is implemented before the step of forming E1 reliefs.

According to a first variant of this second embodiment, the step of deposition E2 of material comprises integrally joining by compression at least one blank of a layer of material 41*, 42 superimposed on the surface of a blank of a first layer 11*. FIG. 16 specifically illustrates a variant in which two layers 41*, 42* (or blanks of layers) are superimposed on the surface of a blank of a first layer 11*. These three blanks may each take the form of a raw blank or preform. The parameters of this integral joining, in particular the duration, pressures, temperatures, etc., are chosen in particular so as to obtain an assembly resulting from combining said three blanks, in which the material of each of the layers 11*, 41*, 42* is not completely crosslinked and/or the dimensions of which are not definitive, in order to facilitate the implementation of the step of integrally joining E3 a transparent or translucent protective layer 2*, as will be specified below.

The method then comprises a second step which consists in forming E1 reliefs on said surface of the assembly formed by the three superimposed layers 11*, 41*, 42*. According to this second embodiment, cavities 3* are formed in at least one of the surface layers 42*, 41*, using a laser, in particular a femtosecond pulse laser, the trajectory of which is defined so as to correspond to a predefined pattern 111*. The depth of the cavities may vary so as to reveal the second layer 41* or the first layer 11*. This depth may completely or partially remove the third layer 42* or the second layer 41*, in other words the depth of the cavities may correspond to the thickness of the third layer 42* or to the sum of the thicknesses of the third layer 42* and the second layer 41*. Alternatively, this depth is slightly less, so as to not completely remove one of the third layer 42* or second layer 41*, while still allowing the lower layer to be seen through the remaining part of the layer partially removed.

Advantageously, the substrate 1* is thus in the form of a layer 11* on which are deposited different layers 41*, 42* forming reliefs having different visual appearances, such as different colors. Like the timepiece component 10 resulting from the method according to the first embodiment, the timepiece component 10* also comprises a second transparent or translucent protective layer 2* the lower surface 200* of which is in contact with at least the upper surface 110* of the upper layer of the substrate.

The method then comprises a step of integrally joining E3 a transparent or translucent protective layer 2* to the substrate 1* having the reliefs, obtained by the steps described above from the three layers 11*, 41*, 42* superimposed and assembled together. This step is carried out in the same way as in the case of the first embodiment, starting from a blank of a transparent or translucent protective layer 2a*, notably made from a material which is not completely crosslinked, or which has dimensions which are not definitive. This blank is compressed against the assembly obtained previously, under pressure and temperature conditions chosen to obtain good adhesion of this blank, which then ultimately forms a top protective layer.

As in the case of the timepiece component 10 resulting from the method according to the first embodiment, depending on the flexibility of the blank 2a* and the pressure and temperature conditions, the two parts 1* and 2* may be integrally joined partially or fully. The parts 1* and 2* may thus be integrally joined only on the upper surface 110* of the upper layer of the substrate 1* and the lower surface 200* of the layer 2*. They may also be advantageously integrally joined over all of the surfaces of the reliefs 111* and the lower surface 200* of the layer 2*, as in FIG. 16.

According to a second variant embodiment of this second embodiment, the two steps E1, E3 of the method may be reversed. To be specific, the step of integrally joining E3 the transparent or translucent protective layer 2* may be carried out before the step E1 of forming the reliefs. To be specific, cavities 3* may be produced by laser through the transparent or translucent protective layer 2*, in order to obtain the component 10*.

According to a variant depicted schematically in FIG. 17, the upper surface of the transparent or translucent protective layer may not be flat and/or continuous, but may for example have cavities, likewise forming a pattern for example conforming to the reliefs 111*. Advantageously, such a pattern may correspond to all or part of a pattern formed by the deposition of material and/or by reliefs of the substrate. Such an embodiment may be implemented in all variants of all embodiments.

Naturally, the steps of the different variants and different embodiments described may be combined with one another to form other variant embodiments.

For example, the same timepiece component may comprise cavities colored by depositing material according to the first embodiment of the method and cavities passing through at least partially so as to reveal at least one other layer of the substrate according to the second embodiment of the method.

In all cases, the method for manufacturing a timepiece component includes the following three steps, as shown in FIG. 18, in an order which may vary, as described above:
Forming E1 reliefs on a polymer substrate of the timepiece component;
Depositing E2 material on at least a part of said substrate;
Integrally joining E3 a transparent or translucent protective layer to all or some of said reliefs and/or of the deposit of material.

The invention also relates to a timepiece or jewelry component as such obtained by the method according to the invention. As mentioned, such a timepiece component may be a bracelet portion. In the context of this description, “bracelet portion” means a finished or semi-finished product. It may be a ready-to-wear bracelet portion: in this case, the substrate of the portion is preferably intended to come into contact with the wearer's wrist. Alternatively, it may be a piece of a bracelet portion featuring the outer covering of the bracelet portion, which may be intended, for example, to be attached to an inner structure, for example “tear-proof”. More generally, the timepiece component may be a finished or semi-finished product.

In a variant, it may be any exterior component of a wristwatch, such as a bezel disk that may be attached to a bezel ring or a dial that may be assembled within a watch case.

The timepiece component comprises a substrate made of polymer material comprising reliefs and at least partially a deposit of material, and all or some of said reliefs are covered by a transparent or translucent protective layer.

The thickness of the substrate is adapted to the timepiece component to be manufactured. It may be between 0.5 mm and 3 mm, whether it comprises one or more layers. The thickness of the transparent or translucent protective layer may be between 0.2 mm and 0.5 mm, or between 0.2 mm and 0.3 mm. A substantial thickness, of the order of 0.5 mm, will be preferred for the second protective layer in order to reinforce or highlight the color of the at least one layer of the substrate.

In the context of this description, “blank” means an element prefiguring a substrate or a layer whatever its stage of manufacture.

According to the first embodiment described above, the substrate and its reliefs form a one-piece assembly made of polymer material.

According to the second embodiment described above, the substrate is in the form of a layer without reliefs, on which the deposit of material is deposited so as to form reliefs.

According to the first embodiment, the deposit of material may be applied to only part of the area having the reliefs. Advantageously, it may be applied exclusively to projections of said reliefs or exclusively in cavities of said reliefs, in particular on areas of the reliefs at the same height. This latter approach makes it possible to highlight the reliefs and amplify them visually. For this reason, the deposition of material is carried out using a material that produces a particular visual effect, as mentioned above, for example a particular color, different from the rest of the substrate.

Advantageously, whatever the embodiment, the substrate may also comprise at least one area without said deposit of material.

Furthermore, in particular in the first embodiment, it is also possible to color the projections complementarily to the cavities of the reliefs, for example with a different material, having a different color, to highlight the difference between these parts of the reliefs. In the case of the first variant of the first embodiment, only the cavities of the structured surface 240 could comprise a deposit of material 4 so as to color only the projections of the reliefs 111.

The deposit of material may be a deposit of metal or a metal alloy or a deposit of a paint, a lacquer, a varnish, or a composite, in particular with a luminescent, phosphorescent or fluorescent material.

All or part of the substrate, in particular at least one layer, and/or said transparent or translucent protective layer are made of a polymer material, for example a thermoplastic or thermoset polymer, or a polymer-based material, i.e. comprising at least 50% by weight of polymer material, and therefore predominantly polymer, and advantageously an elastomer or elastomer-based material, in particular a fluoroelastomer (FKM, FFKM or FEPM), or a natural rubber (NR) or synthetic rubber (SBR, HNBR, EPDM), or a vinyl methylsilicone (VMQ) or a fluorosilicone (FVMQ).

Advantageously, the materials of the at least one layer of the substrate and of the transparent or translucent protective layer are compatible, such that they adhere to one another independently of any additional means such as an adhesive. In particular, the polymers of the at least one layer of the substrate and of the transparent or translucent protective layer opposite have the same chemical nature in order to promote crosslinking between them. Preferably, the polymers selected belong to the same chemical family, in particular the family of fluoroelastomers. In other words, the materials chosen advantageously comprise the same polymer matrix.

The reliefs of the substrate may comprise all or some of the following features:
at least one relief having a height, measured in the direction perpendicular to the timepiece component, between 1 nm and 2 mm, or between 1 nm and 500 μm, or between 1 nm and 10 μm, or between 1 nm and 10 nm; and/or
several reliefs which intersect, and/or
at least one cavity having an opening narrower than its greatest width or comprising a lower section parallel to the structured surface of larger area than another parallel section positioned above the lower section.

The invention does not relate to the reliefs as such. The pattern formed by the reliefs of the substrate may be any pattern, and for example feature esthetic and/or functional marking.

Thus, the cavities 3; 3* of the reliefs may have any shape. They may have a V-shaped section, as shown in FIG. 10, or a crenellation-type section (with sides perpendicular or substantially perpendicular to the surface of the timepiece component), as shown in FIGS. 15 and 16. They may of course have much more complex shapes, in particular in the case where the pattern formed on the at least one first layer is obtained according to the first variant of the first embodiment, in particular using a model element. Furthermore, in the case of a multilayer substrate, these cavities may be blind, in other words they do not completely pass through at least one surface layer of the substrate; equally, they may be through cavities or at least partially transparent so as, for example, to reveal other layers of the substrate.

The invention also relates to a wristwatch comprising at least one timepiece component as described above.

1. A timepiece component comprising:
a substrate made of polymer or polymer-based material comprising reliefs, and
at least partially a deposit of material,
wherein all or some of the reliefs are covered by a transparent or translucent protective layer.

2. The timepiece component as claimed in claim 1, wherein
the substrate and the reliefs form a one-piece assembly made of polymer material, or
the substrate has a shape of a layer without reliefs, on which the deposit of material forms reliefs.

3. The timepiece component as claimed in claim 1, wherein the deposit of material is applied to areas of the reliefs at a same height.

4. The timepiece component as claimed in claim 1, wherein the substrate comprises at least one area without the deposit of material.

5. The timepiece component as claimed in claim 1, wherein the deposit of material is a deposit of a material selected from the group consisting of a metal, a metal alloy, a paint, a lacquer, a varnish, and a composite.

6. The timepiece component as claimed in claim 1, wherein the substrate and/or the transparent or translucent protective layer is or are made of an elastomer or elastomer-based material.

7. The timepiece component as claimed in claim 1, wherein the reliefs of the substrate comprise at least one of the following:
at least one of the reliefs has a height, measured in a direction perpendicular to the timepiece component, in a range of from 1 nm to 2 mm; and/or
a plurality of the reliefs intersect; and/or
at least one cavity has an opening narrower than a greatest width of the at least one cavity, or has a lower section parallel to a structured surface of larger area than another parallel section positioned above the lower section.

8. A method for manufacturing a timepiece component, wherein the method comprises:
forming reliefs on a substrate made of polymer or polymer-based material of the timepiece component;
depositing material on at least a part of the substrate; and
integrally joining a transparent or translucent protective layer to all or some of the reliefs and/or of the deposit of material.

9. The method as claimed in claim 8, wherein the informing of the reliefs on the substrate comprises molding a polymer substrate in a mold so as to form reliefs.

10. The method as claimed in claim 9, wherein the depositing of the material comprises depositing the material on reliefs of a surface of the mold or of a structured insert placed in the mold so that the deposit of material is transferred onto the substrate during the molding of the substrate.

11. The method as claimed in claim 9, wherein the molding of the substrate comprises:
acquiring a model element comprising a structured surface having a pattern to be reproduced on a surface of a timepiece component;
covering the Covering structured surface of the model element with a molding resin capable of reproducing a pattern, in negative, of the pattern of the structured surface, and allowing the molding resin to solidify so as to obtain a structured insert;
separating the structured insert from the model element, the structured insert comprising a surface comprising the pattern in negative; and
placing the structured insert in the mold, so as to form reliefs of the substrate using the structured insert.

12. The method as claimed in claim 8, wherein the method comprises depositing material on a layer of the substrate, then forming the reliefs on the substrate by partially removing the material, so as to form the reliefs of the substrate using the deposit of material.

13. The method as claimed in claim 12, wherein the material deposited is a polymer.

14. The method as claimed in claim 12, wherein the forming of the reliefs on the substrate comprises partially removing the material by a laser.

15. The method as claimed in claim 8, wherein the substrate and the transparent or translucent protective layer are made of respective polymer materials which are compatible, so that the integrally joining of the transparent or translucent protective layer causes direct adhesion of the transparent or translucent protective layer to all or part of the substrate upon crosslinking of the respective polymer materials.

16. The method as claimed in claim 11, further comprising:
cutting the structured insert to a format corresponding to at least part of the timepiece component to be manufactured.

17. The method as claimed in claim 13, wherein the material deposited is an elastomer or based on an elastomer, wherein the elastomer is selected from the group consisting of a fluoroelastomer (FKM, FFKM or FEPM), a natural rubber, a synthetic rubber (SBR, HNBR, EPDM), a vinyl methylsilicone (VMQ), and a fluorosilicone (FVMQ).

18. The timepiece component as claimed in claim 3, wherein the deposit of material is applied to projections of the reliefs or in cavities of the reliefs.

19. The timepiece component as claimed in claim 5, wherein the deposit of material is a deposit of a luminescent, phosphorescent or fluorescent material.

20. The timepiece component as claimed in claim 6, wherein the elastomer or elastomer-based material is selected from the group consisting of a fluoroelastomer (FKM, FFKM or FEPM), a natural rubber, a synthetic rubber (SBR, HNBR, EPDM), a vinyl methylsilicone (VMQ), and a fluorosilicone (FVMQ).
